(19) United States
(12) Patent Application Publication
(10) Pub. No.: US 2017/0017391 A1
(43) Pub. Date: Jan. 19, 2017

(54) ELECTRONIC DEVICE HAVING COVER AND METHOD FOR CONTROLLING DISPLAY THEREOF

(71) Applicant: Samsung Electronics Co., Ltd., Gyeonggi-do (KR)

(72) Inventors: Jihun Hong, Seoul (KR); Whajin Lee, Suwon-si (KR)

(21) Appl. No.: 15/209,496

(22) Filed: Jul. 13, 2016

(30) Foreign Application Priority Data
Jul. 13, 2015 (KR) 10-2015-0098988

(51) Int. Cl. G06F 3/0488; G06F 3/0481; G06F 3/0484; G06F 1/16; G06F 1/18; G06F 3/0482

(52) U.S. Cl. CPC G06F 3/04883; G06F 1/181; G06F 3/0482; G06F 3/04845; G06F 1/1677; G06F 3/04817; G09G 2330/04

(57) ABSTRACT

The present disclosure relates to an electronic device having a cover and a method for controlling a display of the electronic device. A method for controlling a display of the electronic device according to various embodiments of the present disclosure may include activating a specific area to arrange an item in an item arrangement state, displaying an item candidate group in a side area of a touch screen display of the electronic device if the specific area is activated, selecting at least one item from the item candidate group, and arranging the selected item in the specific area.

Another method for controlling a display of the electronic device according to various embodiments of the present disclosure may include receiving an event in a state that a cover is closed, activating a first area of a touch screen display of the electronic device if the received event is a notification event, and displaying a screen corresponding to the notification event by activating a second area of the touch screen display of the electronic device if opening of the cover is detected.

### CROSS-REFERENCE TO RELATED APPLICATION(S) AND CLAIM OF PRIORITY

The present application is related to and claims the benefit under 35 U.S.C. §119(a) of Korean Patent Application No. 10-2015-0098988, filed on Jul. 13, 2015, which is hereby incorporated by reference for all purposes as if fully set forth herein.

### TECHNICAL FIELD

Various embodiments of the present disclosure relate to an electronic device having a cover and a method for controlling a display thereof.

### BACKGROUND

Generally, a cover can be used to protect a display of an electronic device having a touch input function. The display can be protected by covering the front side of the display with the cover. The cover may have a transparent window in a portion, and a user can identify information, such as year/month/date/time information and battery residual amount information through the transparent window. Further, if a telephone call is received by the electronic device, the electronic device can identify a touch input through the transparent window so that the user can respond to the telephone call.

### SUMMARY

To address the above-discussed deficiencies, it is a primary object to provide a method for controlling a display and an electronic device supporting the same according to various embodiments of the present disclosure may be configured with a cover having a transparent window at the front side of the electronic device so that various functions available in the electronic device can be provided through an area determined by a user.

Further, a method for controlling a display and an electronic device supporting the same according to various embodiments of the present disclosure can provide a user interface that can customize an arrangement of an item desired by a user in a state that the cover is closed onto the display of the electronic device.

Further, a method for controlling a display and an electronic device supporting the same according to various embodiments of the present disclosure can provide customized item information through the user interface in a state that the cover is closed onto the display of the electronic device.

An electronic device according to various embodiments of the present disclosure may include a touch screen display, a cover formed with a transparent material and configured to operate the touch screen display in a state that at least a portion of the touch screen display is covered, and a processor configured to activate an adjustable specific area of the touch screen display according to a user gesture input in a state that the cover is closed.

An electronic device according to various embodiments of the present disclosure may include a touch screen display; a cover formed with a transparent material and configured to operate the touch screen display in a state that at least a portion of the touch screen display is covered; a sensing unit configured to detect a closed state or an open state of the cover; and a processor configured to receive an event in a state that the cover is closed, to activate a first area of the touch screen display if the received event is a notification event, and to control the touch screen display to display a screen corresponding to the notification event by activating a second area of the touch screen display if opening of the cover is detected through the sensing unit.

A method for controlling a display of the electronic device according to various embodiments of the present disclosure may include activating a specific area to arrange an item in an item arrangement state, displaying an item candidate group in a side area of a touch screen display of the electronic device if the specific area is activated, selecting at least one item from the item candidate group, and arranging the selected item in the specific area.

Another method for controlling a display of the electronic device according to various embodiments of the present disclosure may include receiving an event in a state that a cover is closed, activating a first area of a touch screen display of the electronic device if the received event is a notification event, and displaying a screen corresponding to the notification event by activating a second area of the touch screen display of the electronic device if opening of the cover is detected.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate an electronic device according to various embodiments of the present disclosure;

FIG. 2 illustrates a configuration of an electronic device according to various embodiments of the present disclosure;

FIG. 3 illustrates a method for controlling a display of an electronic device according to various embodiments of the present disclosure;

FIGS. 4A to 4G illustrate configurations of an electronic device at different stages of a method for controlling a display of an electronic device according to various embodiments of the present disclosure;

FIG. 5 illustrates a method for controlling a display of an electronic device according to various embodiments of the present disclosure;

FIG. 6 illustrates a method for controlling a display of an electronic device according to various embodiments of the present disclosure;

FIG. 7 illustrates a detailed process of performing operation 607 in FIG. 6; and

FIGS. 8A to 8D illustrate configurations of an electronic device at different stages of a method for controlling a display of an electronic device according to various embodiments of the present disclosure.

### DETAILED DESCRIPTION

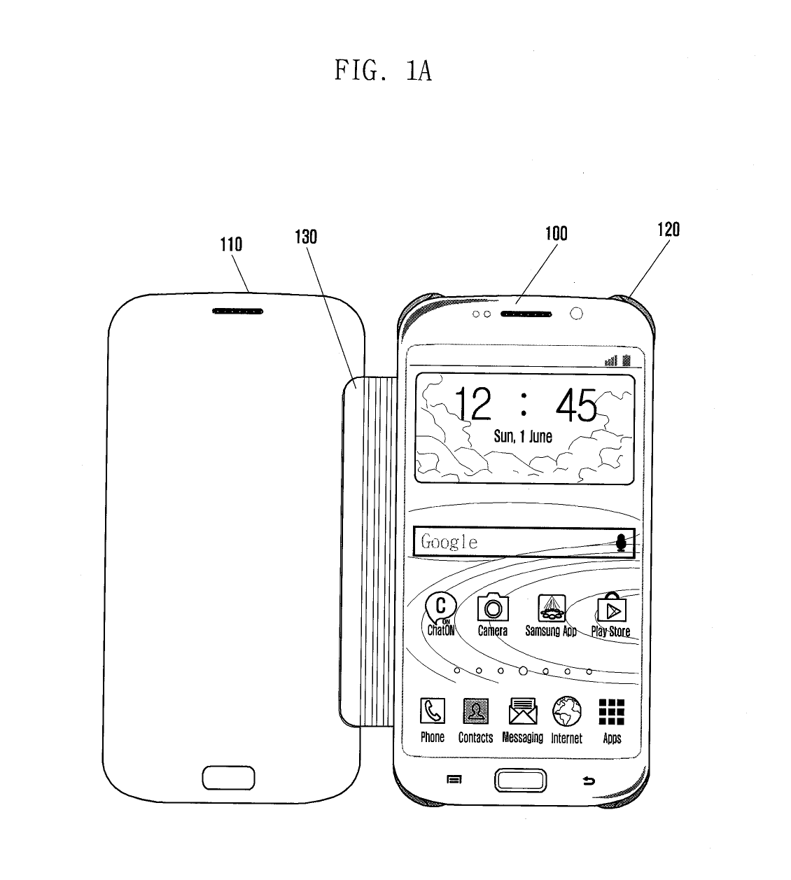

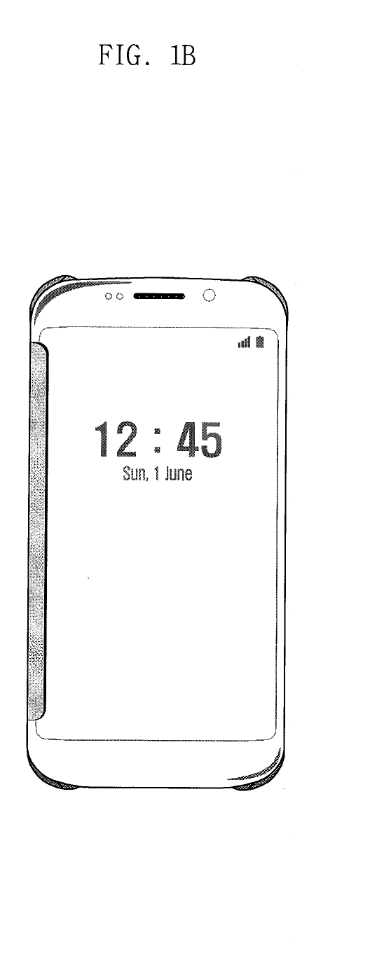

FIGS. 1A through 8D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The expressions “comprise” and “include” used in the present disclosure indicate the existence of a correspondingly disclosed function, operation, or component, and they are not limited to at least one of an additional function, operation, or component. Further, it is meant by the terms “include” and “have” in the present disclosure that a characteristic, number, step, operation, element, component, or their combination exists in the disclosure; therefore, it should be understood that the existence or additional possibility of at least one characteristic, number, step, operation, element, component, or their combination is not excluded.

In the detailed description of the present disclosure, expressions “A or B”, “at least one of A and/or B”, and “one or more A and/or B” may include one of the listed words and their combinations. For example, “A or B”, “at least one of A and B”, and “at least one A or B” may mean all of (1) including at least one A, (2) including at least one B, and (3) including at least one A and at least one B

The terms are merely used to describe an embodiment of the present disclosure, and they do not limit the scope and spirit of the present disclosure. It is to be understood that the singular forms “a”, “an”, and “the” include plural referents unless the context dictates otherwise.

Unless the context clearly dictates otherwise, all the terms including a technical or scientific term used in the present disclosure will have the same meaning generally understood by those skilled in the art. It should be understood that terms defined in a generally used dictionary have the same meaning as in a related technical context, and they are not to be interpreted in an abnormal or excessively formal meaning unless clearly indicated in the present disclosure.

An electronic device according to various embodiments of the present disclosure may include at least one of a smartphone, tablet PC (Personal Computer), mobile phone, video phone, e-book reader, netbook computer, PDA (Personal Digital Assistant), PMP (Portable Multimedia Player), MP3 player, camera, or wearable device such as an electronic clothing, electronic bracelet, electronic appcessory, electronic tattoo, smart mirror, and smart watch.

Hereinafter, an electronic device according to various embodiments of the present disclosure is described referring to the accompanying drawings. In this disclosure, the term “user” may indicate a person using an electronic device or a device using an electronic device (for example, artificial intelligent electronic device).

In various embodiments of the present disclosure, a flip cover type case may be combined with the electronic device. The flip cover type case may include a cover covering the front side of the electronic device. The cover may be formed with a transparent material. In various embodiments of the present disclosure, if a partial area of a touch screen display is activated in a state that the front side of the electronic device is covered by the cover, an item displayed in the partial area can be transmitted through the cover having a transparent partial area.

In an embodiment of the present disclosure, the item may include an application icon installed in the electronic device and a web page favorite icon.

In an embodiment of the present disclosure, “item arrangement area” is an area for managing items displayed according to activation of a partial area and responding to generation of an event in a state that a flip cover type case is combined with the electronic device and a case cover is closed. In various embodiments of the present disclosure, the electronic device can arrange an item in the item arrangement area by adding the item. Further, the electronic device can move the location of the item arranged in the item arrangement area or delete the added item from the item arrangement area. Arranging an item desired by a user through the item arrangement area may be convenient for the user because the user can identify information of an item without having to open the cover.

FIGS. 1A and 1B are schematic drawings illustrating an electronic device according to various embodiments of the present disclosure.

Referring to FIGS. 1A and 1B, FIG. 1A illustrates an open state of a cover 110 whose flip cover type case is combined with the electronic device 100, and FIG. 1B illustrates a closed state of the cover 110 whose flip cover type case is combined with the electronic device 100 (i.e., a state that the front side of the electronic device 100 is closed by the cover).

In various embodiments of the present disclosure, the electronic device 100 can be combined with a flip cover type case. As shown in FIG. 1A, the flip cover type case may be configured with a holder 120 for securely fixing the electronic device 100 and a cover 110 for covering the front side of the electronic device 100. Further, the flip cover type case may include a connector 130 for connecting the holder 120 and the cover 110.

In various embodiments of the present disclosure, the cover 110 may be formed with a transparent material so that light can pass through at least a partial area of a touch screen display of the electronic device 100. If a specific character or numeral is displayed on the touch screen display of the electronic device 100, the specific character or numeral can be displayed outwards through the partial area of the cover 110 formed with a transparent material.

In various embodiments of the present disclosure, in case that the cover 110 is formed with a transparent material through which light can pass from a partial area of the touch screen display, a color displayed outwards may be different from a color displayed on the touch screen display. For example, as shown in FIG. 1B, in case that at least a partial area of the touch screen display is formed with a pink, blue, or green material, if a flip cover type case is combined with the electronic device 100 and the front side of the electronic device 100 is closed by the cover 110, the color of light passed through the partial area of the cover 110 may differ according to the color of the transparent material. Further, in various embodiments of the present disclosure, if at least a partial area of the touch screen display is activated, the electronic device 100 can detect a user input through the activated partial area of the touch screen display.

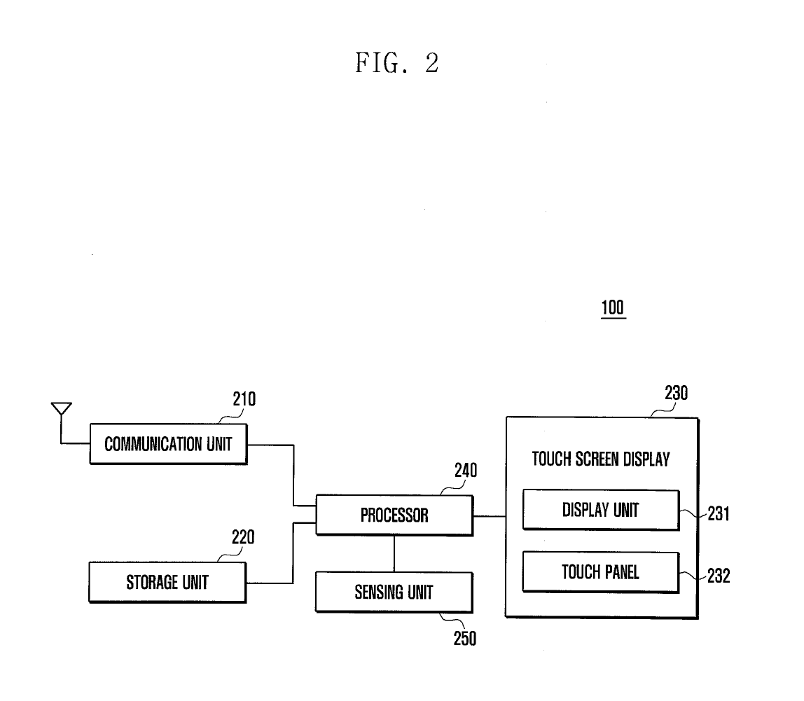

FIG. 2 is a block diagram illustrating a configuration of an electronic device according to various embodiments of the present disclosure.

Referring to FIG. 2, the electronic device 100 according to an embodiment of the present disclosure may include a communication unit 210, storage unit 220, touch screen display 230, processor 240, and sensing unit 250.

The communication unit 210 can connect the electronic device 100 with an external electronic device. For example, the communication unit 210 can connect with an external electronic device through a wired or wireless communication network. The wireless communication may include a Wi-Fi (Wireless Fidelity), BT (Bluetooth), and NFC (Near Field Communication). Further, the wireless communication may include at least one cellular communication such as an LTE, LTE-A, CDMA, WCDMA, UMTS, WIBRO, or GSM. The wired communication may include at least one of a USB (Universal Serial Bus), HDMI (High Definition Multimedia Interface), RS-232 (Recommended Standard 232), or POTS (Plain Old Telephone Service).

The storage unit 220 may be configured with a program memory for storing an operating program of the electronic device 100 and a data memory for storing log information, content, and object generated while executing a program.

Particularly in an embodiment of the present disclosure, the storage unit 220 can store a program which controls at least a partial area (for example, first area or second area) of the touch screen display according to an event generated in a state that the cover 110 of the flip cover type case combined with the electronic device 100 is closed. Further, the storage unit 220 can store information related to locations of items arranged in a screen arrangement area, display of an item candidate group to be arranged in the item arrangement area, and a method for displaying the items.

The touch screen display 230 can be configured in an integral form including a display unit 231 and a touch panel 232. The display unit 231 can display various screens according to the use of the electronic device 100 under the control of the processor 240. The display unit 231 may be configured with an OLED (Organic Light Emitted Diode), AMOLED (Active Matrix Organic Light Emitted Diode), flexible display, bended display, or 3-dimensional display. Further, the display unit 231 may be configured in a flexible, transparent, or wearable form. The touch panel 232 may be configured with a complex touch panel including a hand touch panel for detecting a hand gesture and a pen touch panel for detecting a pen gesture.

Particularly in an embodiment of the present disclosure, the display unit 231 can display a guide under the control of the processor 240 if the electronic device 100 is in an item arrangement state for arranging an item. If an input signal for adjusting the size of the guide is detected to set the item arrangement area, the touch panel 232 can transmit the detected input signal to the processor 240. Alternatively, if an input signal of drawing a single closed curve is detected to set the item arrangement area, the touch panel 232 can transmit the detected drawing signal to the processor 240.

If the item arrangement area is set under the control of the processor 240, the display unit 231 can display an item candidate group in a side area of the display unit 231. The touch panel 232 can detect an input signal for selecting an item from the item candidate group displayed in the display unit 231, and transmit the detected input signal to the processor 240.

The display unit 231 can display a screen for arranging the selected item in the item arrangement area under the control of the processor 240. If the touch panel 232 detects gesture signals for editing an item arranged in the item arrangement area such as a gesture signal for adjusting the size of an item, gesture signal for moving a location of an item, and gesture signal of deleting an item, the touch panel 232 can transmit the gesture signal to the processor 240.

The display unit 231 can display the item arrangement area including the edited item responding to the editing gesture under the control of the processor 240.

If an event is generated under the control of the processor 240, the display unit 231 can activate at least a partial area of the display unit 231 corresponding to the type of the event.

If the display unit 231 detects generation of a first event under the control of the processor 240, a partial area of the display unit 231 as a first area (i.e., item arrangement area) can be activated. The display unit 231 can display information of an item arranged in the item arrangement area such as current time information, battery information, information of a received message, call reception information, and absence information in response to the activation of the item arrangement area under the control of the processor 240.

If the display unit 231 detects generation of a second event under the control of the processor 240, a second area (i.e., whole area of the display unit 231) can be activated and a corresponding screen (for example, home screen, or previously executed application screen) can be displayed.

The processor 240 controls general operations of the electronic device 100 and signal flows between internal components of the electronic device 100, executes data processing, and supplies power from a battery to the components.

Particularly in an embodiment of the present disclosure, the processor 240 can determine an item arrangement state according to an input for detecting a closed state of the cover 110 (i.e., a state that the front side of the electronic device 100 is closed by the cover 110) and the flip cover type case is combined with the electronic device 100, or according to an input for detecting a long press in a state that the flip cover type case is combined with the electronic device 100 and the cover 110 is closed.

The processor 240 can detect a gesture to set an area for arranging the item in the item arrangement state. In the item arrangement state, the processor 240 can display a guide in the touch screen display 230. The guide is used to set the item arrangement area easily and may have a rectangular form. The processor 240 can set the item arrangement area in a rectangular form corresponding to an input for adjusting the size of the guide. Alternatively, the processor 240 can set an area formed by drawing a single closed curve as an item arrangement area.

The processor 240 can display an item candidate group in a side area of the touch screen display 230 if the item arrangement area is set. The processor 240 can arrange an item selected from the displayed item candidate group in the item arrangement area. If a touch input generated at an item among the item candidate group, or an input of selecting an item from the item candidate group and dragging/releasing the item into the item arrangement area is detected, the processor 240 can arrange the item in the item arrangement area.

If the item is arranged in the item arrangement area, the processor 240 can perform editing operations such as an operation of adjusting the size of the item arranged in the item arrangement area, operation of moving the location of the item arranged in the item arrangement area, and operation of deleting the item arranged in the item arrangement area.

If an event is detected, processor 240 can identify the type of the event and activate at least a partial area of the touch screen display 230 corresponding to the type of the event. In an embodiment of the present disclosure, the event may include a first event and a second event.

If a first event is generated, the processor 240 can activate at least a partial area of the touch screen display 230 as a first area (i.e., item arrangement area). The processor 240 can display information of an item arranged in the item arrangement area such as current time information, battery information, information of a received message, call reception information, and absence information in response to the activation of the item arrangement area.

If a second event is generated, the processor 240 can activate a second area (i.e., whole area of the display unit 231) and display a corresponding screen (for example, home screen, or previously executed application screen).

The sensing unit 250 measures a physical quantity or detects an operating state of the electronic device 100, and converts the measured or detected information to an electric signal. For example, the sensing unit 250 may include a hall sensor configured with a magnetic material.

Particularly in an embodiment of the present disclosure, the hall sensor can be installed in the cover 110. The hall sensor installed in the cover 110 can detect an open or closed state of the cover 110. Namely, the sensing unit 250 can detect whether the cover 110 is closed or opened over the front side of the touch screen display 230 and transmit a corresponding signal to the processor 240.

Further, the electronic device 100 can selectively include components having additional functions such as a GPS (Global Positioning System) module for receiving location information, audio processing unit including a microphone and a speaker, camera module for taking an image or a video, broadcast module for receiving a broadcasting signal, and input unit supporting a hard key based input; however, descriptions and drawings related to the above components will be omitted hereafter.

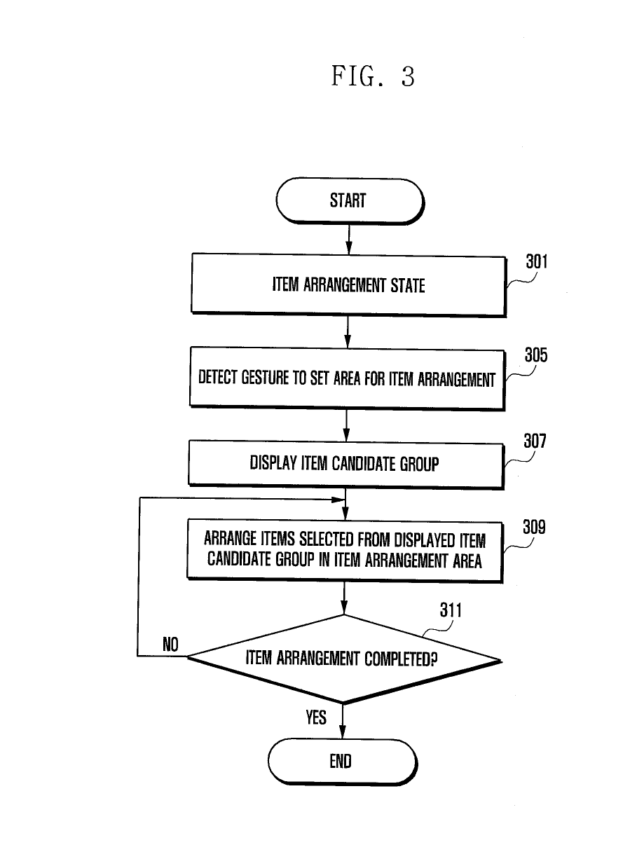

FIG. 3 is a flowchart illustrating a method for controlling a display, of an electronic device according to various embodiments of the present disclosure.

Referring to FIG. 3, the processor 240 detects an item arrangement state at operation 301. In various embodiments of the present disclosure, the item may include an application icon installed in the electronic device 100 and a web page favorite icon.

In various embodiments of the present disclosure, the electronic device 100 can determine the item arrangement state by detecting at least one of a state that the flip cover type case is combined with the electronic device 100 and the cover 110 is closed (i.e., the front side of the electronic device 100 is covered by the cover 110) and a state that the flip cover type case is combined with the electronic device 100 and a long press is detected.

The electronic device 100 described hereafter according to various embodiments of the present disclosure is assumed to be combined with a flip cover type case and determines the item arrangement state by detecting a long press in a state that the cover 110 of the flip cover type case is closed.

If a long press is detected at a state that the cover 110 of the flip cover type case combined with the electronic device 100 is closed, the processor 240 determines that the electronic device is in the item arrangement state and detects a gesture of setting an area for arranging the item (hereafter, item arrangement area) at operation 305. Namely, the processor 240 can detect a gesture for activating a specific area of the touch screen display 230.

In various embodiments of the present disclosure, the processor 240 can display a guide in the touch screen display 230 in the item arrangement state. A user can set an item arrangement area easily through the guide. The guide may be formed in a rectangular form. If an input for adjusting the size of the rectangle (for example, an input for increasing or decreasing the size of the rectangle) is detected, the processor 240 can set the item arrangement area with a rectangular size corresponding to the input.

In various embodiments of the present disclosure, it is assumed that the guide is displayed in the item arrangement state; however, the present disclosure is not limited to this and the item arrangement area can be set through a drawing in case that the guide is not displayed. For example, the processor 240 can set an area generated by drawing a single closed curve as the item arrangement area.

If the item arrangement area is set, the processor 240 displays an item candidate group in a side area of the touch screen display 230 at operation 307. The side area of the touch screen display 230 may include a right, left, upper, or lower area. In an embodiment of the present disclosure, it is assumed that the item candidate group is displayed in a lower area of the touch screen display 230.

As described above, the item candidate group may include an application icon and a web page favorite icon which can be arranged in the item arrangement area. Further, the item candidate group can be displayed in the lower area of the touch screen display 230 according to at least one of the order of names, frequency of application execution, and order set by a user.

The processor 240 arranges an item selected from the displayed item candidate group in the item arrangement area at operation 309. In various embodiments of the present disclosure, the processor 240 can detect an input for selecting an item from the item candidate group displayed in the side area of the touch screen display 230. If an input for selecting an item is detected, the processor 240 can arrange the selected item in the item arrangement area. In various embodiments of the present disclosure, the input for selecting an item may include a touch input detected from an item among the item candidate group, and an input for selecting an item from the item candidate group and dragging/releasing into the item arrangement area.

In various embodiments of the present disclosure, the processor 240 can arrange the items sequentially in the item arrangement area responding to inputs for selecting the items. Alternatively, the processor 240 can arrange the item in a location of the item arrangement area where the item is selected, dragged, and released.

In various embodiments of the present disclosure, if an item is arranged in the item arrangement area, the processor 240 can perform an operation of editing the arranged item. The operation of editing the item may include an operation of resizing an item arranged in the item arrangement area, operation of moving a location of an item arranged in the item arrangement area, and operation of deleting an item arranged in the item arrangement area. However, the present disclosure is not limited to this.

The processor 240 determines completion of the item arrangement at operation 311. Namely, the processor 240 can detect an input for terminating the item arrangement state. For example, the processor 240 may determine that the item arrangement state is terminated if an input for selecting an item from the item candidate group is not detected for a predetermined time, or if an operation of editing an item in the item arrangement area is not detected. However, the present disclosure is not limited to this, and the item arrangement area may include a separate confirm button. If the confirm button is pressed, the processor 240 can determine that the item arrangement state is terminated. Beside this, in various embodiments of the present disclosure, an input for terminating the item arrangement state can be detected.

If the item arrangement is completed, the processor 240 can terminate the item arrangement state. If an input for terminating the item arrangement state is not detected, the processor 240 branches off to operation 309, and repeats the operation of arranging an item selected from the item candidate group in the item arrangement area.

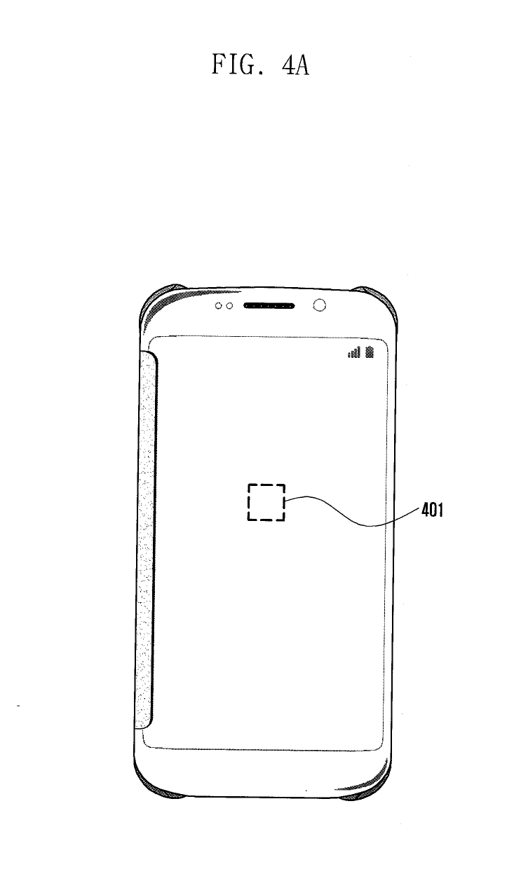

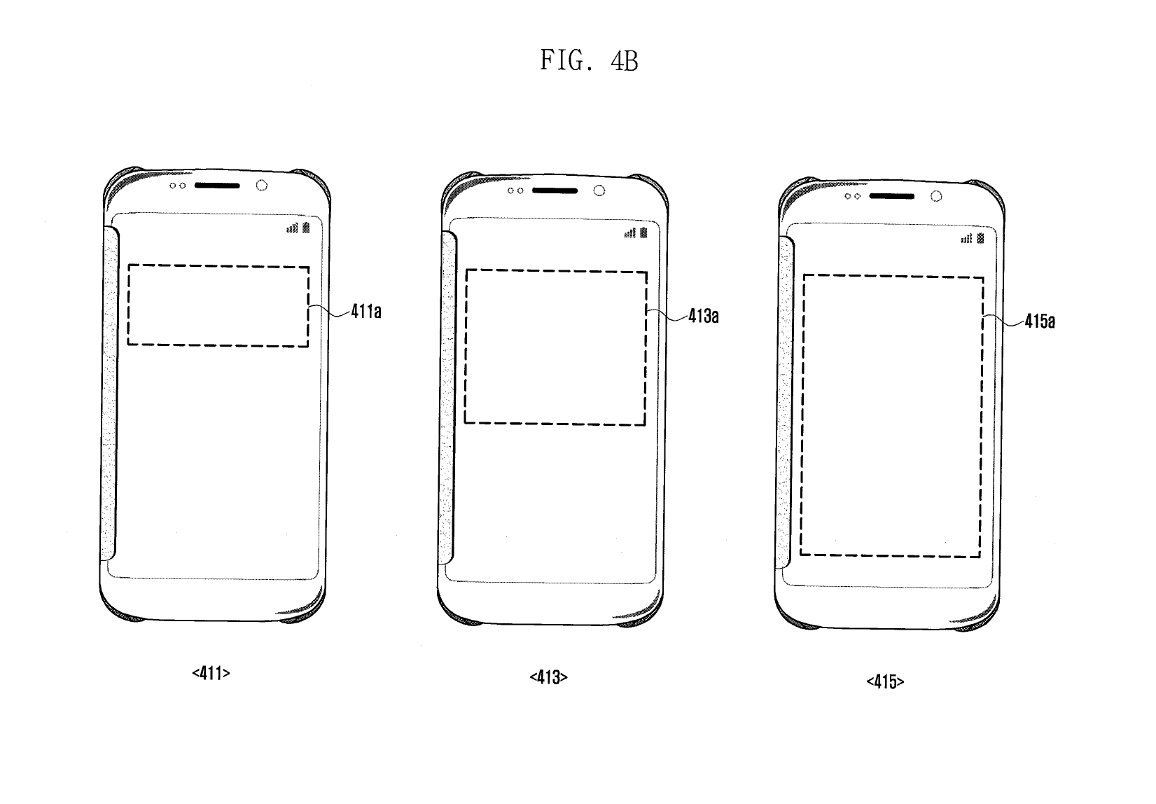

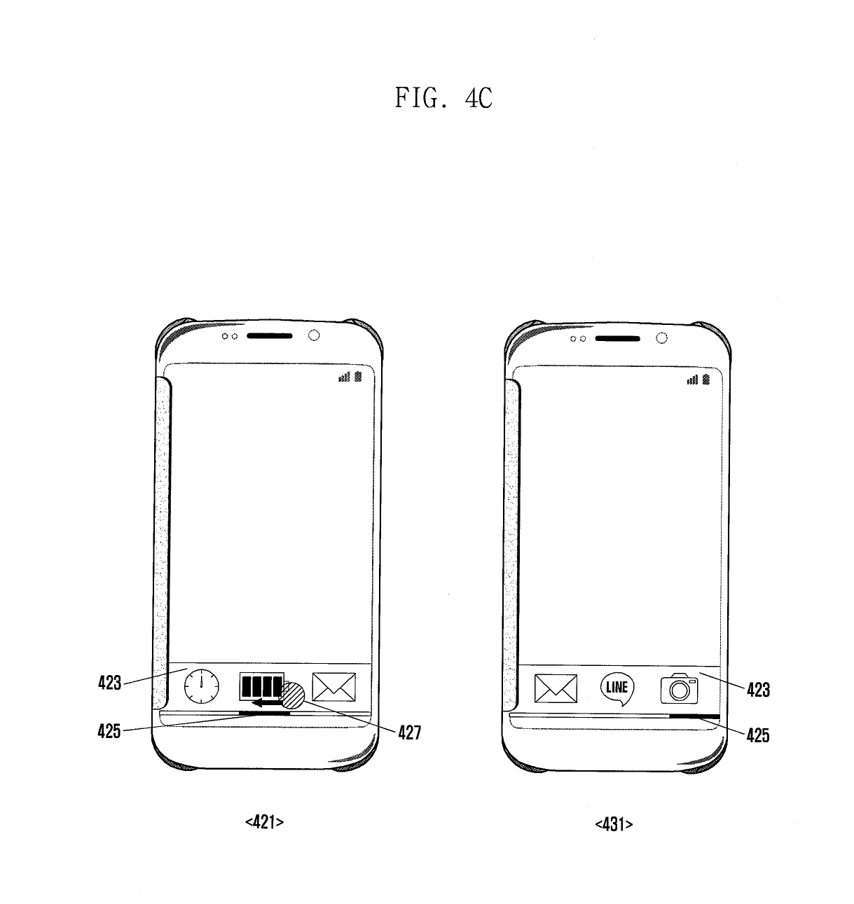

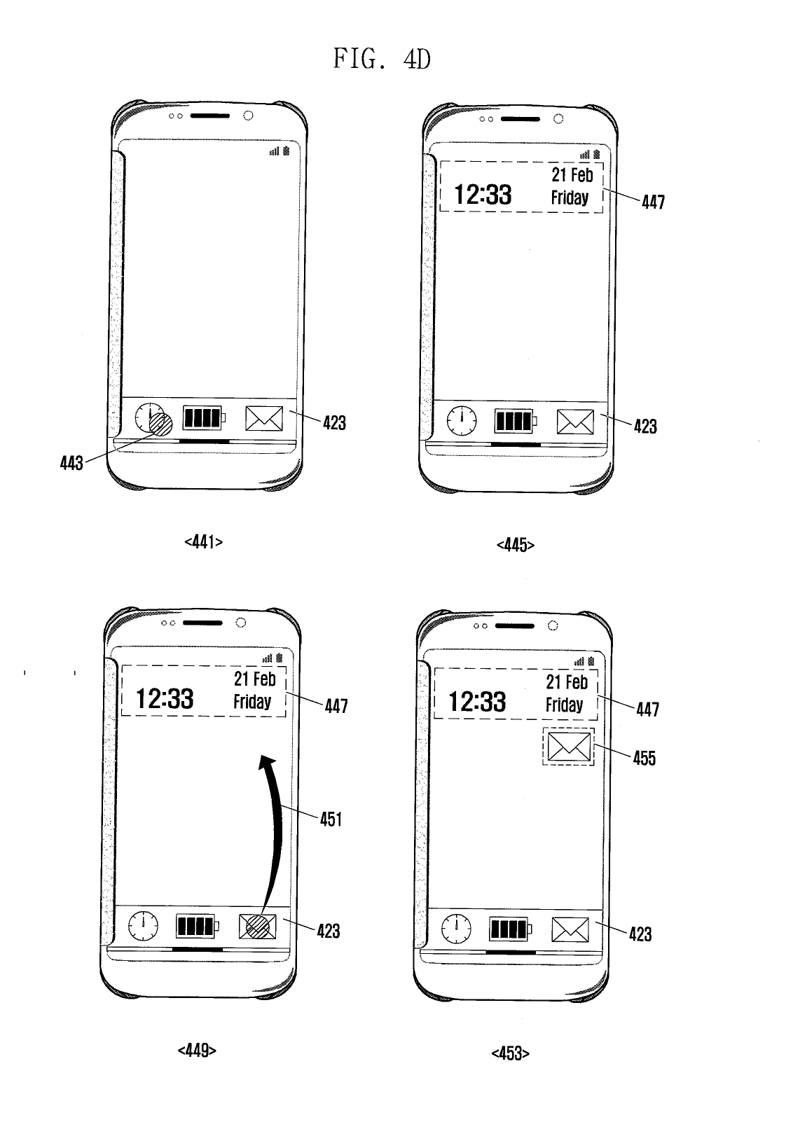

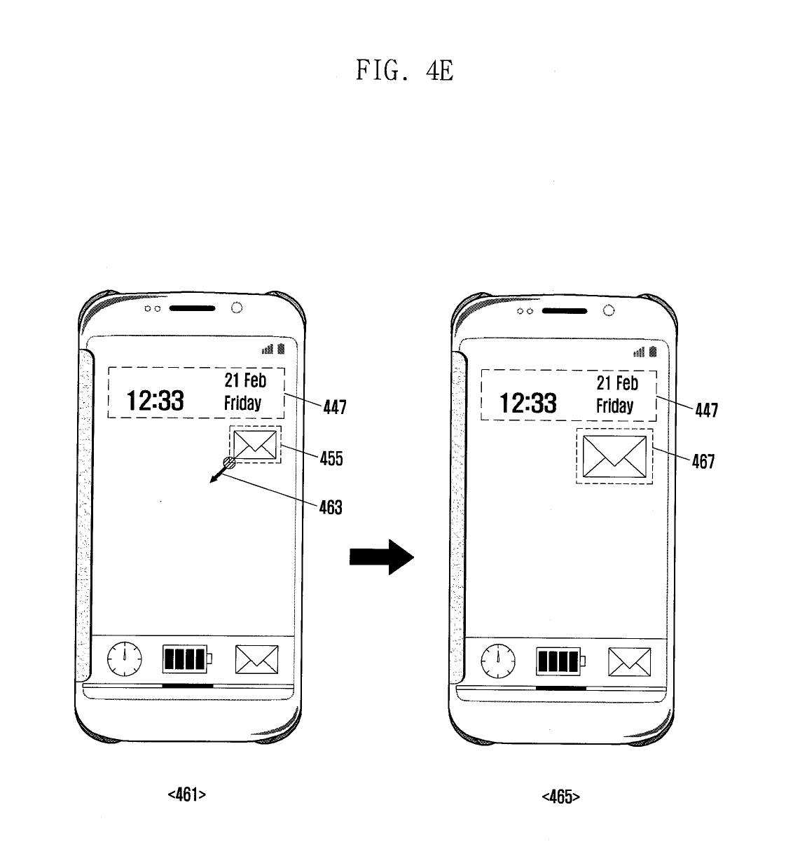

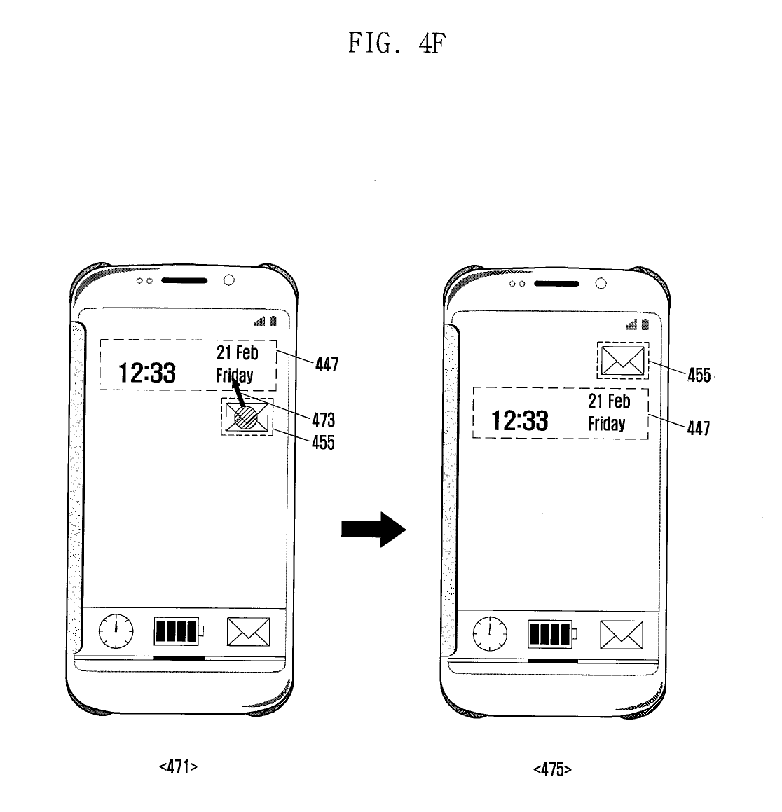

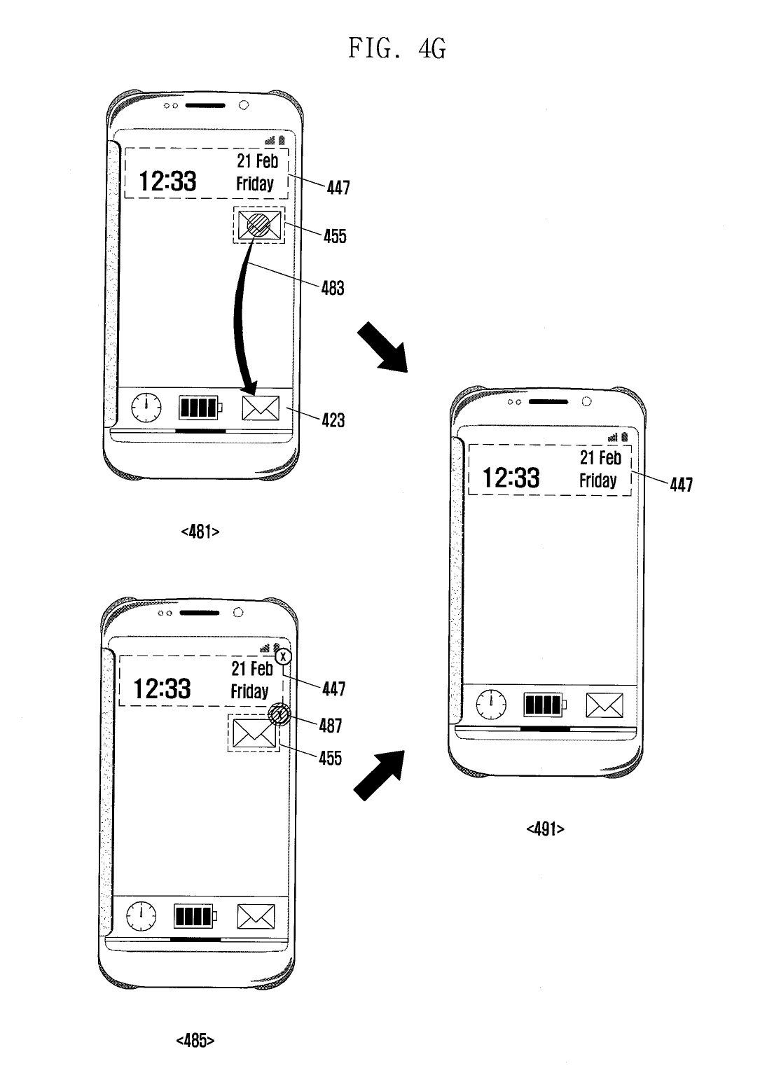

FIGS. 4A to 4G are schematic drawings illustrating a method for controlling a display of an electronic device according to various embodiments of the present disclosure.

Referring to FIGS. 4A to 4G, if a long press is detected in a state that the cover 110 of a flip cover type case is combined with the electronic device 100, the processor 240 determines the item arrangement state and displays a guide 401 as shown in FIG. 4A. Alternatively, if the cover 110 of a flip cover type case combined with the electronic device 100 is identified to be closed, the processor 240 determines the item arrangement state and displays a guide 401 as shown in FIG. 4A. The guide 401 is an embodiment being displayed for an easier setting of the item arrangement area, and the guide 401 may not be displayed.

In various embodiments of the present disclosure, the processor 240 can set the item arrangement area by adjusting the size of the guide 401 as shown by 411a of 411, 413a of 413, 415a of 415 in FIG. 4B. However, the present disclosure is not limited to this; and, in various embodiments of the present disclosure, the processor 240 can set an area for arranging an item by drawing a line if the guide 401 is not displayed. For example, if an action of drawing a single closed curve such as a triangle, rectangle, circle, or polygon is detected, the processor 240 can set the area of the triangle, rectangle, circle, or polygon formed by drawing as the item arrangement area.

If the item arrangement area is set, the processor 240 can display an item candidate group 423 in a side area of the touch screen display 230 as shown by 421 of FIG. 4C. The item candidate group 423 may include an application icon installed in the electronic device and a web site favorite icon.

The item candidate group 423 may include a plurality of items, and the processor 240 may display a scroll bar 425 if the plurality of items is not completely displayed in the side area. For example, if a drag 427 to the left is detected in a state that a clock item, battery item, and character message item are displayed in the item candidate group 423, the processor 240 moves the item candidate group 423 to the left direction and displays hidden items such as an IM message item and a camera item as shown by 431 of FIG. 4C.

In various embodiments of the present disclosure, the processor 240 can add items selected from the item candidate group 423 in the item arrangement area. For example, if a gesture 443 for selecting a clock item from the item candidate group 423 is detected as shown by 441 of FIG. 4D, the processor 240 can display the clock item in the item arrangement area as shown by 447 of 445 in FIG. 4D. Here, the clock item can be arranged sequentially in the item arrangement area. However, the present disclosure is not limited to this, and if a gesture 451 of selecting, dragging, and releasing a character message item from the item candidate group 423 to the item arrangement area is detected as shown by 449 of FIG. 4D, the processor 240 can arrange the character message item in the item arrangement area as shown by 455 of 453 in FIG. 4D. Here, the character message item may be arrange at a location of the item arrangement area where the gesture is released. Namely, items in the item arrangement area can be arranged at a fixed location or freely at a location designated by a user.

In various embodiments of the present disclosure, when arranging an item of the item candidate group 423 in the item arrangement area, the processor 240 can arrange a plurality of identical items in the item arrangement area. For example, the processor 240 can arrange a plurality of clock items in the item arrangement area by repeatedly selecting from the item candidate group 423. The processor 240 can set the plurality of clock items arranged in the item arrangement area with different time zones. Accordingly, a user can identify the times in different countries without opening the cover 110.

In various embodiments of the present disclosure, if an item is arranged in the item arrangement area, the processor 240 can perform an operation of editing the arranged item. As described before, in various embodiments of the present disclosure, the operation of editing an item may include an operation of adjusting the size of an item arranged in the item arrangement area, operation of moving a location of an item arranged in the item arrangement area, and operation of deleting an item arranged in the item arrangement area.

The operation of editing an item will be described referring to FIGS. 4E to 4G.

In various embodiments of the present disclosure, the processor 240 can adjust the size of an item arranged in the item arrangement area. For example, as shown by 461 of FIG. 4E, the processor 240 can detect an input 463 for adjusting the size of the character message item 455 in a state that the clock item 447 and the character message item 455 are arranged in the item arrangement area. Responding to the input 463 for adjusting the size, the processor 240 can display a resized character message item 467 as shown by 465 of FIG. 4E.

In various embodiments of the present disclosure, the processor 240 can detect a gesture for moving a location of an item arranged in the item arrangement area. For example, as shown by 471 of FIG. 4F, the processor 240 can detect an input 473 for moving the character message item 455 to the location of the clock item 447 in a state that the clock item 447 and the character message item 455 are arranged in the item arrangement area. Responding to the input 473 for moving the item, the processor 240 can display by interchanging the locations of the clock item 447 and the character message item 455 as shown by 475 of FIG. 4F.

In various embodiments of the present disclosure, the processor 240 can detect an input for deleting an item arranged in the item arrangement area. For example as shown by 481 of FIG. 4G, if a drag 483 for selecting the character message item 455 arranged in the item arrangement area continues to the area of the item candidate group 423, the processor 240 can delete the character message item 455 from the item arrangement area and display a screen arranged with the clock item 447 positioned as shown by 491 of FIG. 4G.

Alternatively in various embodiments of the present disclosure, the clock item 447 and the character message item 455 arranged in the item arrangement area may include a delete icon as shown by 485 of FIG. 4G. If an input touching the delete icon is detected, the processor 240 can delete an icon corresponding to the touched delete icon in the item arrangement area. For example, if an input 487 touching the delete icon included in the character message item 455 is detected, the processor 240 can delete the character message item 455 from the item arrangement area. Namely, as shown by 491 of FIG. 4G, the character message item 455 is deleted from the item arrangement area, and a screen arranged with the clock item 447 displayed as seen in an embodiment of the disclosure.

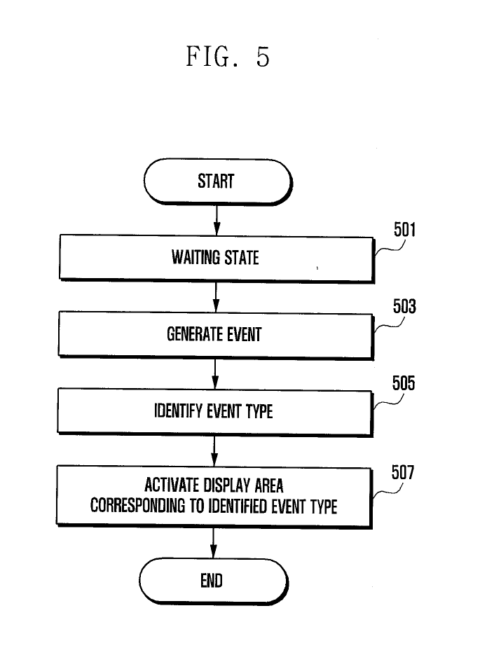

FIG. 5 illustrates a method for controlling a display of an electronic device according to various embodiments of the present disclosure.

Referring to FIG. 5, the processor 240 maintains a waiting state at operation 501. In an embodiment of the present disclosure, the waiting state may be a state that the electronic device 100 is performing the basic operation. For example, the touch screen display 230 of the electronic device 100 may maintain an inactive state, operate periodically to identify a call reception or a message reception, or wait for a specific input from a user.

If an event is detected in the waiting state at operation 503, the processor 240 identifies the type of event at operation 505. In various embodiments of the present disclosure, the event may include a first event and a second event. The first event may include a power key input event and notification events such as a mail reception and a message reception, which are detected in a state that the cover 110 of a flip cover type case combined with the electronic device 100 is closed. The second event may include an event of which the cover 110 of a flip cover type case combined with the electronic device 100 switches from a closed state to an open state.

The processor 240 activates an area of the touch screen display 230 corresponding to the type of event at operation 507. For example, if a first event is generated, the processor 240 can activate a first area of the touch screen display 230. The first area may be an item arrangement area set by a user's gesture as shown by 411a, 413a, or 415a of FIG. 4B.

In various embodiments of the present disclosure, the processor 240 can display information of an item arranged in the item arrangement area responding to the activation of the item arrangement area. The item information may include current time information, battery information, information of a received message information, call reception information, and absence information.

If a second event is generated, the processor 240 activates a second area (i.e., whole area of the touch screen display 230) and displays a corresponding screen (for example, a home screen or a previously execute application screen).

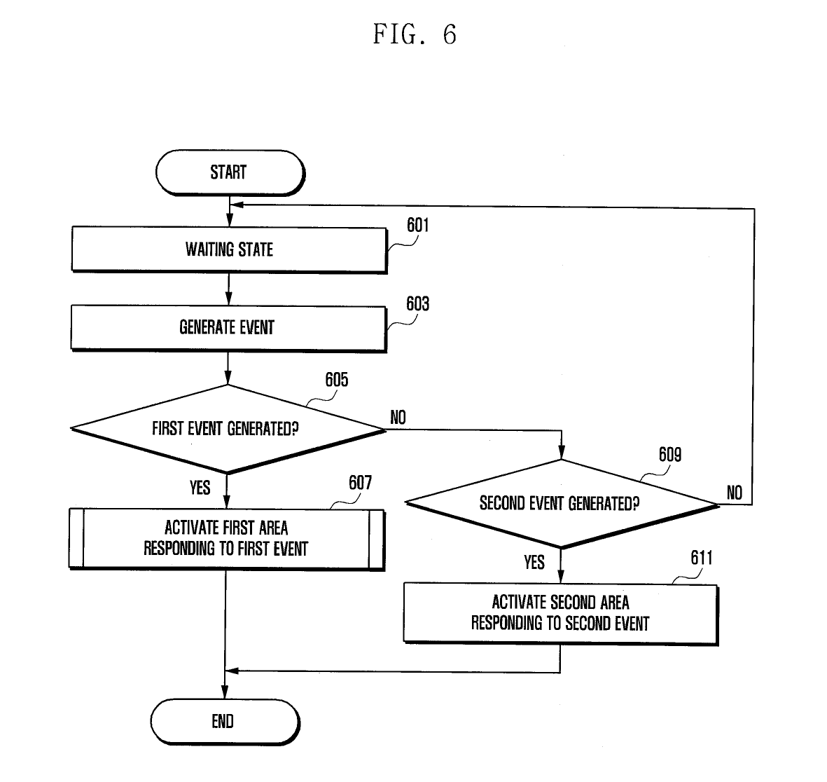

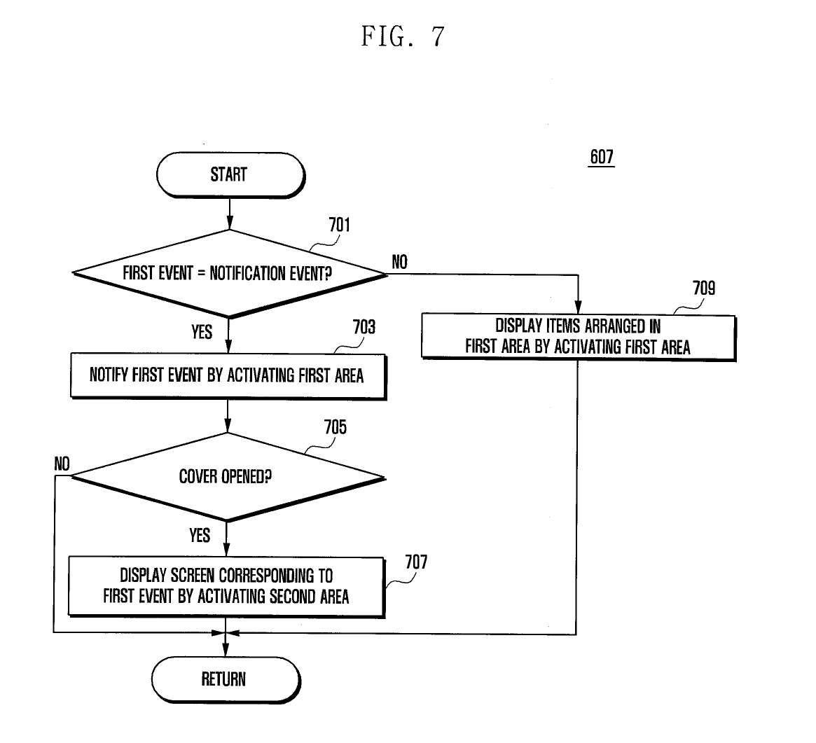

The operations of FIG. 5 will be described in more detail referring to FIGS. 6 and 7.

FIG. 6 is a flowchart illustrating a method for controlling a display of an electronic device according to various embodiments of the present disclosure.

Referring to FIG. 6, while maintaining a waiting state at operation 601, the processor 240 detects generation of an event at operation 603. As described above, the event may include a first event and a second event.

The processor 240 identifies whether the generated event is a first event at operation 605. As described above, the first event may include a power key input event and notification events such as a mail reception and a message reception, which are detected in a state that the cover 110 of a flip cover type case combined with the electronic device is closed.

If the event is a first event, the processor 240 activates at least a partial area of the touch screen display 230 as a first area responding to the first event at operation 607.

The operation 607 of FIG. 6 will be described in more detail referring to FIG. 7.

If the event is not a first event, the processor 240 identifies whether the event is a second event at operation 609. As described above, the second event may include an event which switches the cover 110 of a flip cover type case combined with the electronic device from a closed state to an open state.

If the event is a second event, the processor 240 activates a second area of the touch screen display 230 and displays a corresponding screen responding to the second event at operation 611. Namely, the processor 240 can activate the whole area of the touch screen display 230 and display a corresponding screen. For example, the processor 240 can display a home screen or a previously executed application screen.

If the event is not a second event, the processor 240 branches off to operation 601 and maintains a waiting state.

FIG. 7 is a flowchart illustrating a detailed process of operation 607 in FIG. 6.

Referring to FIG. 7, the processor 240 identifies whether a first event corresponds to a notification event at operation 701. In various embodiments of the present disclosure, the notification event may include a call reception, message reception, mail reception, information of push service, and SNS notification.

If the first event is a notification event, the processor 240 displays the notification event by activating a first area at operation 703. For example, if a message is received, the processor 240 can display the content of the received message in the first area by activating the first area. Alternatively, if a message is received, the processor 240 can display the notification of the received message in the first area by activating the first area.

The processor 240 identifies whether the cover 110 of a flip cover type case combined with the electronic device is open at operation 705. The cover 110 may be equipped with a sensor for detecting opening or closing of the cover 110. By using the sensor, the processor 240 can identify whether the cover 110 is closed or opened over the front side of the touch screen display 230.

In various embodiments of the present disclosure, if the cover 110 is identified to be open, the processor 240 displays a screen corresponding to the notification event by activating the second area at operation 707. For example, if the notification event is a message reception event, the processor 240 can execute a message application and display a message reception screen by activating the whole area of the touch screen display 230 as a second area, if the message is received and the cover 110 is open.

In various embodiments of the present disclosure, the processor 240 can detect at least one of a touch input, hovering input, and electronic pen input from an area corresponding to the received notification event in a state that the cover 110 of a flip cover type case combined with the electronic device 100 is closed. The processor 240 can execute a corresponding operation responding to the at least one input. For example, if a plurality of messages is detected, the processor 240 can detect the opening of the cover 110 after detecting an input for selecting one from the plurality of messages. If an input for selecting an item and opening of the cover 110 are detected, the processor 240 can execute a message application and display a message reception screen by activating the whole area of the touch screen display 230 as a second area.

If the first event is not a notification event, the processor 240 displays an item arranged in the activated first area at operation 709. For example, the first event may include a power key input event. If the power key input event is detected, the processor 240 can display information of the item arranged in the item arrangement area by activating the first area. As described above, the information of item may include current time information, battery information, information of a received message, call reception information, and absence information.

In various embodiments of the present disclosure, the form of displaying the information of an item arranged in the information item arrangement area can be changed by a user. For example, the clock item arranged in the item arrangement area can be displayed in an analog or digital form according to a user setting. Alternatively, the battery item arranged in the item arrangement area can be displayed in a gauge or numeral form according to the user setting. If a character message event is received, the content of the received message or the notification for the received message can be displayed.

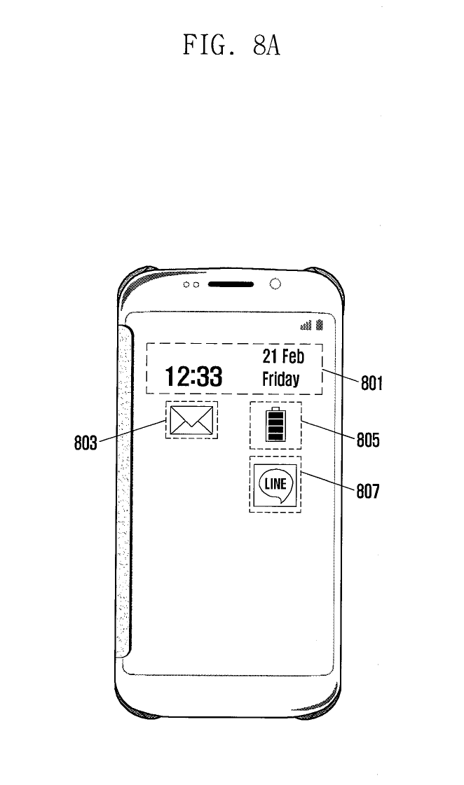

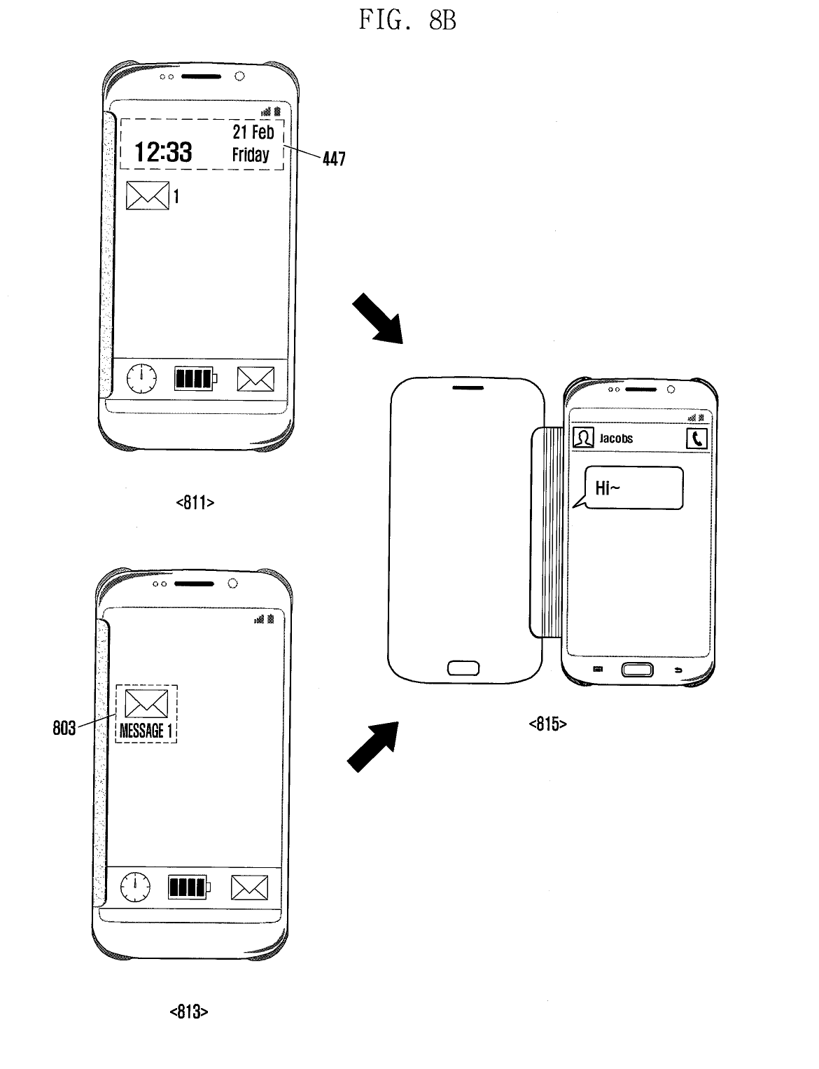

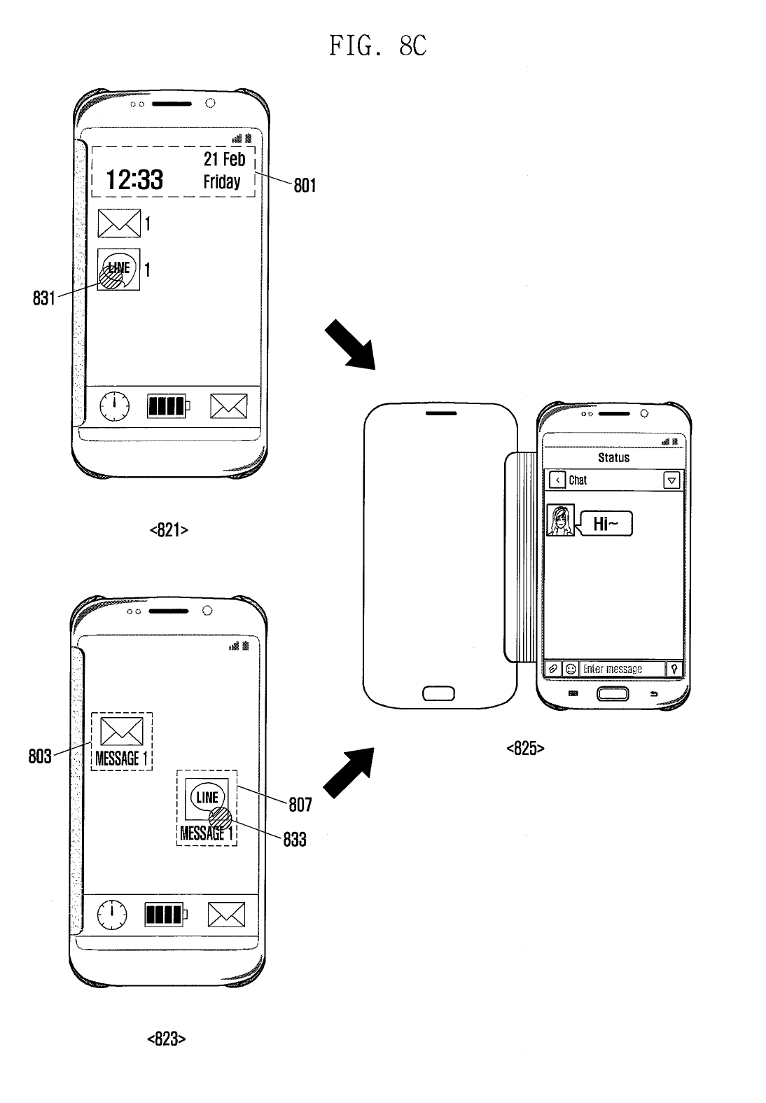

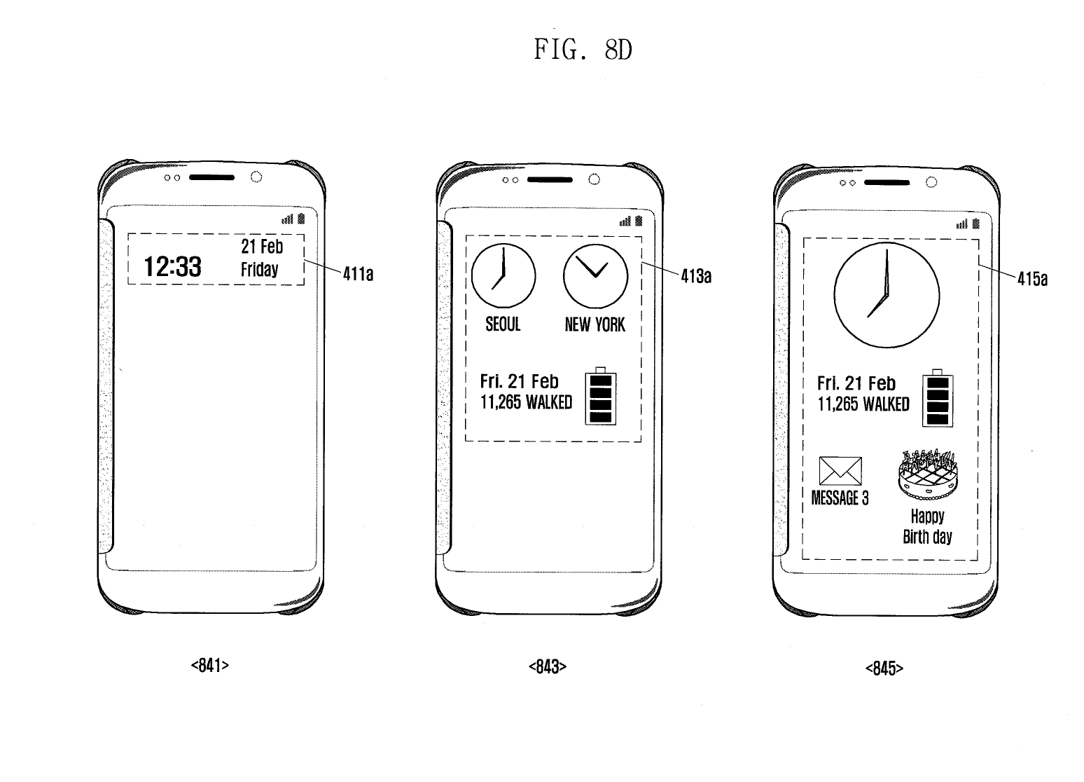

FIGS. 8A to 8D are schematic drawings illustrating a method for controlling a display of an electronic device according to various embodiments of the present disclosure.

Referring to FIGS. 8A to 8D, a clock item 801, character message item 803, battery item 805, and IM message item 807 can be arranged in a first area as an item arrangement area as shown in FIG. 8A. In various embodiments of the present disclosure, the electronic device 100 may maintain a basic operation (i.e., inactive state of the touch screen display 230), operate periodically to identify a call or message reception, or wait for a specific input from a user.

In the waiting state, the processor 240 can receive a character message as shown by 811 and 813 of FIG. 8B. In an embodiment of the present disclosure, if a character message is received, the processor 240 can display a notification that a character message has been received as shown by 811 of FIG. 8B. Here, the area of the clock item 477 can be set to activate as a default. However, the present disclosure is not limited to this, and the clock item 477 may not be set to activate as a default.

Alternatively in various embodiments of the present disclosure, if the generated event is an item arranged in the first area as shown by 813 of FIG. 8B, the processor 240 can activate the first area where the item is located. Namely, if a character message reception event is generated, the processor 240 does not activate the whole area of the first area as an item arrangement area but activates the area of a character message item 803 and clock item 801 in the first area, and controls to deactivate the areas of a battery item 805 and an IM message item 807.

After outputting the notification by activating a partial area or the whole area of the first area responding to the reception of the character message, the processor 240 can detect opening of the cover of a flip cover type case combined with the electronic device. If the opening of the cover 110 is detected, the processor 240 can display the received character message by activating a second area of the touch screen display 230 and executing a character message application as shown by 815 of FIG. 8B.

In various embodiments of the present disclosure, if a plurality of events is received, the processor can notify the plurality of events in the first area as shown by 821 and 823 of FIG. 8C. For example, the plurality of events is assumed to be a character message event and an IM message reception event.

If the character message and the IM message are received, the processor 240 can display a notification for the event as shown by 821 of FIG. 8C. Namely, the notification can indicate that a character message and an IM message have been received. Here, the area of the clock item 801 can be set to activate as a default. However, the present disclosure is not limited to this, and the area of the clock item 801 may be set inactive.

Alternatively in various embodiments of the present disclosure, if the character message and the IM message are received, the processor 240 can identify whether the received character message and IM message are items arranged in the first area as shown by 823 of FIG. 8C. If the character message and the IM message are items arranged in the first area, a notification can be displayed by activating the partial areas of the first area where the character message and the IM message item are arranged. Namely, if the event of character message and IM message is received, the processor 240 does not activate the whole area of the first area but activates the areas of the character message item 803 and the IM message item 807 in the first area, and can control to deactivate the areas of the clock item 801 and the battery item 805.

In various embodiments of the present disclosure, the processor 240 can detect an input for selecting one of the received character message and IM message. For example, the processor 240 can detect an input 831 for selecting the received IM message and opening of the cover 110 attached to the electronic device in a state that the reception of the character message and the IM message is being notified as shown by 821 of FIG. 8C. Responding to the input 831 for selecting the IM message and the opening of the cover 110 attached to the electronic device, the processor 240 can execute a messenger application and display an IM message screen by activating the second area of the touch screen display 230 as shown by 825 of FIG. 8C.

Alternatively in various embodiments of the present disclosure, responding to the reception of the character message and the IM message, the processor 240 can output a notification by activating the areas corresponding to the character message item 803 and the IM message item 807 in the first area as shown by 823 of FIG. 8C. The processor 240 can detect an input 833 for selecting an area corresponding to the IM message item 807 among the activated areas and opening of the cover attached to the electronic device. If the input 833 for selecting an area corresponding to the IM message item 807 and opening of the cover 110 are detected, the processor 240 can execute a chatting application and display an IM message screen by activating the second area of the touch screen display 230 and executing a messenger application as shown by 825 of FIG. 8C.

In various embodiments of the present disclosure, the processor 240 can detect a power key input event. Responding to the power key input event, the processor 240 can display information of an item arranged in the first area as shown in FIG. 8D. As described above, the item information may include current time information, battery information, information of a received message, call reception information, and absence information.

In various embodiments of the present disclosure, if the first area is set to 411a as shown by 411 of FIG. 4B, the processor 240 can display information of an arranged item by activating the first area 411a responding to the power key input event as shown by 841 of FIG. 8D. If the first area is set to 413a as shown by 413 of FIG. 4B, the processor 240 can display information of an arranged item by activating the first area 413a responding to the power input event as shown by 843 of FIG. 8D. If the first area is set to 415a as shown by 415 of FIG. 4B, the processor 240 can display information of an arranged item by activating the first area 415a responding to the power input event as shown by 845 of FIG. 8D.

A method for controlling a display and an electronic device supporting the same according to various embodiments of the present disclosure can set functions provided through a transparent window formed at the front side of a cover. The functions provided through the transparent window can be set by a user, and thereby the electronic device can provide more various functions for the user. Further, in various embodiments of the present disclosure, the electronic device can improve user convenience by providing customized item information for the user in a state that the cover covers a display of the electronic device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a touch screen display configured to operate when at least a portion of the touch screen display is covered;
a cover formed to include a transparent material and configured to cover at least the portion of the touch screen display; and
a processor configured to activate an adjustable specific area of the touch screen display using a user gesture input when the cover is closed.

2. The electronic device of claim 1, wherein the processor is further configured to:
display a guide in the touch screen display, and
set and activate the specific area to arrange an item by adjusting the guide.

3. The electronic device of claim 1, wherein the processor is further configured to set and activate the specific area to arrange an item by drawing a single closed curve.

4. The electronic device of claim 1, wherein the processor is further configured to:
display an item candidate group in a side area of the touch screen display when the specific area is activated, and
arrange an item in the specific area when an input of selecting at least one item from the item candidate group is detected.

5. The electronic device of claim 4, wherein the processor is configured to control to arrange the selected item in the specific area based on at least one of (i) a touch input for selecting an item from the item candidate group or (ii) an input of dragging to the specific area after selection of an item from the item candidate group.

6. The electronic device of claim 5, wherein the processor is further configured to edit an item arranged in the specific area by detecting at least one of:
an input for adjusting a size of the item arranged in the specific area,
an input for moving a location of the item arranged in the specific area, and
an input for deleting the item from the specific area.

7. The electronic device of claim 1, wherein:
the cover comprises a flip cover type case,
the processor is further configured to determine whether the flip cover type case is combined with the electronic device and closure of the combined flip cover type case is detected, or whether a long press is detected when the cover is closed.

8. An electronic device comprising:
a touch screen display configured to operate when at least a portion of the touch screen display is covered;
a cover formed to include a transparent material and configured to cover at least the a portion of the touch screen display is covered;
a sensing unit configured to detect whether the cover is closed or open; and
a processor configured to:
receive an event when the cover is closed,
activate a first area of the touch screen display when the received event is a notification event, and
control the touch screen display to display a screen corresponding to the notification event by activating a second area of the touch screen display in response to opening of the cover being detected using the sensing unit.

9. The electronic device of claim 8, wherein the processor is configured to control the touch screen display to display a screen corresponding to a selected notification event in response to (i) a plurality of the notification events being generated, (ii) an input for selecting at least one item from the plurality of notification events is detected, and (iii) opening of the cover being detected using the sensing unit.

10. The electronic device of claim 8, wherein the processor is configured to control the touch screen display to display information of an item arranged in a first area by activating the first are a when the received event is not a notification event.

11. The electronic device of claim 8, wherein the notification event comprises at least one of a call reception event, a character message reception event, a mail reception event, an IM message reception event, a push service information, or a SNS notification event.

12. A method for controlling a display of an electronic device, the method comprising:
activating a specific area of the display;
displaying an item candidate group in a side area of a touch screen display of the electronic device when the specific area is activated;
selecting at least one item from the item candidate group; and
arranging the at least one selected item in the specific area.

13. The method of claim 12, further comprising:
setting the specific area in the item arrangement state;
wherein setting the specific area comprises at least one of:
setting the specific area by displaying a guide in the touch screen display and adjusting the guide, or
setting the specific area by drawing a single closed curve.

14. The method of claim 12, wherein selecting the at least one item comprises at least one of:
detecting a touch input to select at least one item from the item candidate group; or
detecting an input of dragging to the specific area after selection of the at least one item from the item candidate group.

15. The method of claim 12, further comprising:
editing an item arranged in the specific area;
wherein editing of the item arranged in the specific area comprises at least one of:
adjusting a size of the item arranged in the specific area;
moving a location of the item arranged in the specific area; or
deleting the item from the specific area.

16. The method of claim 12, further comprising:
determining an item arrangement state;
wherein determining the item arrangement state comprises:
detecting a closed state of a cover of a flip cover case combined with the electronic device; and
detecting a long press in a state that the cover is closed.

17. The method of claim 12, wherein the item candidate group comprises an application icon installed in the electronic device and a web site favorite icon.
